(19) United States
(12) Patent Application Publication
(10) Pub. No.: US 2005/0027574 A1
(43) Pub. Date: Feb. 3, 2005

(54) Real-time activity intelligence system and method

(76) Inventors: Purusharth Agrawal, Austin, TX (US); Syed Mohammad Amir Husain, Austin, TX (US)

Correspondence Address: H. DALE LANGLEY, JR.;THE LAW FIRM OF H. DALE LANGLEY, JR. PC, 610 WEST LYNN, AUSTIN, TX, 78703, US

(21) Appl. No.: 10/752,229

(22) Filed: Jan. 6, 2004

Related U.S. Application Data
(60) Provisional application No. 60/438,374, filed on Jan. 7, 2003.

(51) Int. Cl. G06F 17/60

(52) U.S. Cl. 705/7

(57) ABSTRACT

An activity intelligence system includes a channel of a communication, such as a packetized communications network, for example, the Internet. The communication includes data about which activity intelligence is desired. The system includes an interceptor for accessing particular desired data of the communication. A mapper of the system indexes the data so intercepted. A processor of the system performs an operation with the data. The operation can include any of a wide variety of possibilities, such as HTML content analysis, flag generation and response, statistical and business functions, and others. Conventional, customized or other applications can operate on and with the data for determining desired activity intelligence.

### BACKGROUND OF THE INVENTION

The present invention generally relates to real-time intelligence acquisition in automated business transaction and other processes and, more particularly, to real-time monitoring, detection, determination, and analysis of activity signals in computer and communications networks and devices processing data.

Companies strive to increase efficiency in many aspects and activities. Automation of business processes tends to promote efficiency in many instances. Over the last several decades, computing and communications systems and implementations have provided for much of automation. New and improved software and protocols, as well as advances in electronics hardware and other systems and methodologies, encourage further and additional automation. In fact, many business transactions are presently automated or automatable, with corresponding increased efficiency and other advantages. The trend toward automation, particularly for business transaction processes, is expected to continue to rise.

The conventional automation of business transaction processes, primarily by software and hardware and including communications networks, is quite diverse and disparate. There are few, if any, standards consistently followed in applications infrastructure, programning logic, coding, and interfaces. This situation presents severe complications to integration and enterprise-wide and multi-application use, deployment and effectiveness of the automation. It would be a significant improvement in the art and technology to provide effective integration of the disparate and diverse business transaction processes of companies.

Conventionally, the integration of various automated business transaction processes has required application specific implementations. For example, in a software automated business transaction process, the integration of the process with any other process has required application specific interfacing or application specific programming logic. This interfacing or programming logic, as the case may be, has typically necessarily been implemented at the source code or more fundamental levels of the process. To program such interfacing and logic is task and application specific. It is usually a complex and difficult effort and requires software programmers of extensive knowledge and skill. As can be anticipated for this extent of specificity and detail, the interfacing and logic programming is costly, time-consuming, and risky, among other problems. Moreover, there are limitations to the implementability of the integration, including that the extent and points of integration are restricted by factors often beyond control or access.

Other measures have also been employed to achieve integration of various automated business transaction processes, with similar and other impediments to those described above. One such measure is sometimes referred to as data warehousing. In a data warehousing solution to integration of processes, the term “integration” is somewhat of a misnomer—in fact, the data warehousing solution merely provides for a separate, and non-integrated, storage for data from each separate process. As so stored, the data is available and can be batch processed separate from the distinct processes that provide the data—and which separate and distinct processes themselves have no true cross-integration. For example, data obtained in or from one distinct software automated business process can be stored, such as on a networked storage device. As so stored, other distinct software automated business processes can be programmed to obtain or use the data. There is no true integration of the business processes themselves, however, apart from the intermediate storage connected to the separate processes. In such arrangements, interfacing and programming logic for providing and receiving the warehoused data must be particularly devised for each separate and distinct automated business process. Thus, this and other conventional measures for integration and furthering integration are problematic and non-ideal.

It would be a significant improvement in the art and technology to provide simplified and effective integration of separate and disparate automated business processes, particularly for integrating operations of various business transaction applications softwares. Moreover, it would be advantageous if such integration provides real-time and more thorough accessibility (i.e., “visibility”) of the many types of data and information involved in such automated business processes, including, for example, real-time access to intermediate data and states in software processes, as well as the inputs, outputs, user activity, and other usual data and aspects of the processes. Even further, the less intrusive and invasive the mechanism for the integration, the better and more commercially viable is such an integration solution.

The present invention solves problems of past measures employed for integrating, and gaining knowledge and intelligence of user activity in, business transaction processes, such as with Internet-based business transaction processes and applications softwares. Furthermore, the present invention provides numerous advantages and improvements, including, for example, real-time accessibility of desired data and knowledge, and intelligence of and from, separate and distinct business transaction applications and user activity therewith

### SUMMARY OF THE INVENTION

An embodiment of the invention is an activity intelligence system. The system includes a channel of a communication. The system also includes an interceptor for accessing data of the communication, a mapper for indexing the data, and a processor for performing an operation with the data.

Another embodiment of the invention is a method of intelligent analysis of a data. The method includes accessing the data, mapping the data, and processing the data.

Yet another embodiment of the invention is a method of real-time data analysis. The method includes accessing a data communication in real-time, parsing the data communication in real-time, storing a select data of the data communication in real-time, and processing the select data.

Another embodiment of the invention is a system for content extraction. The system includes an interceptor for accessing a data of a communication, a breaker for breaking-up the data of the communication into at least one subset, an analyzer for applying heuristics to the at least one subset, and a vectorizer for creating a scalar value of the at least one subset and transforming the scalar value into a vector.

A further embodiment of the invention is a method of content extraction. The method includes intercepting a data of a communication, breaking-up the data of the communication into at least one subset, applying heuristics to the at least one subset, creating a scalar value corresponding to the at least one subset, transforming the scalar value in a vector, and computing a deviation of the vector compared to another vector.

### BRIEF DESCRIPTION OF THE DRAWINGS

The present invention is illustrated by way of example and not limitation in the accompanying figures, in which like references indicate similar elements, and in which:

FIG. 1 illustrates a system for performing user activity intelligence operations, including a virtual connector, according to certain embodiments of the invention;

FIG. 2 illustrates a method of a virtual connector for performing user activity intelligence operations, according to certain embodiments of the invention;

FIG. 3 illustrates an intelligence system, including the virtual connector, for performing user activity intelligence operations, such as in an on-line business transaction process, according to certain embodiments of the invention;

FIG. 4 illustrates a proxy system, including the virtual connector for maintaining user activity intelligence operations, wherein the proxy arrangement does not require that routing of communications be maintained through a linking server, according to certain embodiments of the invention;

FIG. 5 illustrates a method of HTML content extraction, according to certain embodiments of the invention;

FIG. 6 illustrates an HTML web page, showing pagelets constructed from the page in the method of FIG. 5, according to certain embodiments of the invention;

FIG. 7 illustrates respective HTML web pages with variations in structure in content, according to certain embodiments of the invention;

FIG. 8 illustrates a comparator for deviation computation in comparative analysis of pagelets constructed from respective HTML data in the method of FIG. 5, according to certain embodiments of the invention;

FIG. 9 illustrates three logical layers of a Visibility Management Platform (VPM) of an exemplary system employing an intelligence system according to the foregoing Figures, according to certain embodiments of the invention;

FIG. 10 illustrates various Business Value Models operating in conjunction with the Visibility Management Platform (VPM) of the exemplary system employing an intelligence system according to the foregoing Figures, according to certain embodiments of the invention;

FIG. 11 illustrates data management features of the Visibility Management Platform (VMP) of the exemplary system employing an intelligence system according to the foregoing Figures, according to certain embodiments of the invention;

FIG. 12 illustrates runtime operations in conjunction with the VMP server of the exemplary system employing an intelligence system according to the foregoing Figures, according to certain embodiments of the invention;

FIG. 13 illustrates the VMP server and functionalities in the exemplary system employing an intelligence system according to the foregoing Figures, according to certain embodiments of the invention; and

FIG. 14 illustrates a Configuration Workbench of the exemplary system employing an intelligence system according to the foregoing Figures, according to certain embodiments of the invention.

### DETAILED DESCRIPTION OF THE INVENTION

User Activity Intelligence System:

Referring to FIG. 1, a system 100 for performing user activity intelligence includes a network 102. The network 102 is any communications system of interconnected communicating devices, such as the Internet, an intranet, a virtual private network, or other directly or indirectly communicatively interconnected individual or pluralities of components, elements, processors, or processes. The network communications are operable according to a packetized protocol, such as the transport control protocol/Internet protocol (TCP/IP) or some other packetized communications protocol. The network 1.02, such as the Internet, interconnects various computing and communications devices, for example, among other devices, a client computer 104 and a central computer 110. The interconnections of the network 102, interconnecting the client computer 104 and the central computer 110, are any of a wide variety of communications network connectors, including, for example, wired, wireless, fiber, coax cable, PSTN, cellular, infrared, radio frequency, WAN, LAN, WLAN, Wi-Fi and other conventional communications connectors and implementations and combinations thereof.

The client computer 104 and the central computer 110 are each one or more computing or other communications devices, for example, each including a microprocessor, memory storage, and communications capabilities via the network 102. Although the term “computer” is used herein to identify certain devices and elements, the term is intended to have the broadest meaning with application to the functionalities described, including such matters as data-enabled cellular telephones, personal digital assistants, laptop computers, desktop computers, or any of a wide variety of other processing devices that can communicate packetized data signals. The client computer 104 and the central computer 1110 communicate over the network 102. The signals communicated between the client computer 104 and the central computer 110 are, at least in part, packetized digital data signals. Particularly, the signals can conform to particular packetized protocols of the network 102, such as the standard Internet network protocol TCP/IP.

Continuing to refer to FIG. 1, the central computer 110 is one or more computing devices, such as a server computer or bank of servers. The central computer 110 includes at least one each of a process 112 and an application 114. The application 114 is any of a variety of business transaction processes, implemented on the central computer 110 via hardware and software thereof. The application 114 includes interactivity over the network 102, including packetized data signals communicated with and from the client computer 104.

As an example where the network 102 is the Internet, the application 114 is, for example, a loan application procedure. In the example, information and blank forms is communicated over the network 102 to the client computer 104, from the central computer 110 or another networked device. A user of the client computer 104 inputs data to the forms and the data is communicated, in packetized signal format, over the network 102 to the central computer 110. As those skilled in the art will know and appreciate, the application 114 is any of a plurality of available or future business transaction or other processes, involving interactive inputs and signals in communications from the client computer 104.

Although the application 114 implements the particular business transaction or other processes, the process 112 is a separate operation, implemented in hardware and/or software in connection with the application 114 and its operation. Particularly, the process 112 serves different purposes from the application 114, and uses or employs certain information of or from the application 114 and its operations. The process 112 and the application 114 can be contained on the same computer or bank of computers, as the central computer 110, or alternatively, the process 112 and the application 114 can themselves be in communication over a disparate network including multiple computers and communications features, collectively also identified for simplification purposes herein as the central computer 110. The process 112 and the application 114 are related, in any event, in that the process 112 employs information of and from the application 114. In this respect, it is desirable in some manner to integrate the operations of the process 112 and the application 114. For purposes of example, the application 114 performs a business transaction process such as the exemplary loan procedure mentioned above; whereas the process 112 is an ancillary operation to the business transaction such as for performing customer intelligence gathering, fraud detection, personalization, quality of service management, or other analytical operation.

Continuing to refer to FIG. 1, and particularly the communicative arrows and block 108 identified in phantom, a conventional mode of integrating the process 112 and the application 114 are illustrated. The conventional mode, as discussed in the “Background” sections hereof, includes the separate block 108—e.g., either an integrator operation with specific programming logic and interfacing particular to the process 112 and the application 114, or otherwise a data warehouse storage of data unique to the process 112 and application 114 that is manipulable by a batch operation uniquely therefore, or combinations of these. The block 108 is either included with the central computer 110 or is an entirely separate device and process (i.e., indicated by the phantom lines). The block 108 necessarily intercedes and interferes between the process 112 and the application 114, and also between each of the process 112 and the application 114 and the communications from and to the client computer 104 over the network 102.

In effect, the block 108 merely serves as an intermediary for communications and data handling between the process 112, the application 114, and the communications of the central computer 110 and the client computer 104. The block 108 can integrate operations of the process 112 and the application 114 because the block 108, as such intermediary, receives and delivers communicated signals as desired for the application. In operations, the block 108, by virtue of application specific programming, logic and interfacing, can communicate information as desired for operations of the process 112 and the application 114. The block 108, however, is complex, costly, and intrusive. This is the case because the block 108 must be specifically designed and programmed to provide desired integration, the block 108 must intercept and handle all communications and information, and the block 108 must interface with and appropriately format data and information as required by the respective process 112, application 114, network 102, and client computer 104. The block 108 is, therefore, an undesirable mechanism for integration.

Still referring to FIG. 1, the system 100 includes much more desirable integration implementation via a virtual connector 116. The virtual connector 116 is communicatively connected to the network 102 to selectively extract packetized signals. The virtual connector 116 is also communicatively connected to the process 112. In operations, the virtual connector 116 selectively picks off data communicated over the network 102 and delivers the data to the process 112 with proper semantic, interface and format matching for readability and use by the process 112. The virtual connector 116 is implemented in software and hardware, for example, the virtual connector 116 can be part of the central computer 110 (e.g., either included therewith or communicatively connected thereto) or can be separate from the central computer 110. As later discussed in more detail, the virtual connector 116 includes an interceptor, mapper and semantic processor, each coordinated to extract desired data information from packetized signals and to deliver the content appropriately matched to and for use by the processor 114.

Virtual Connector:

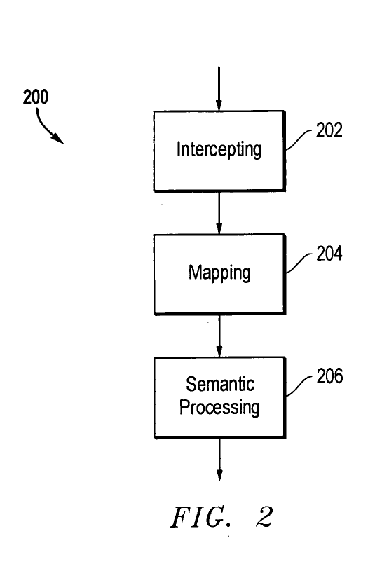

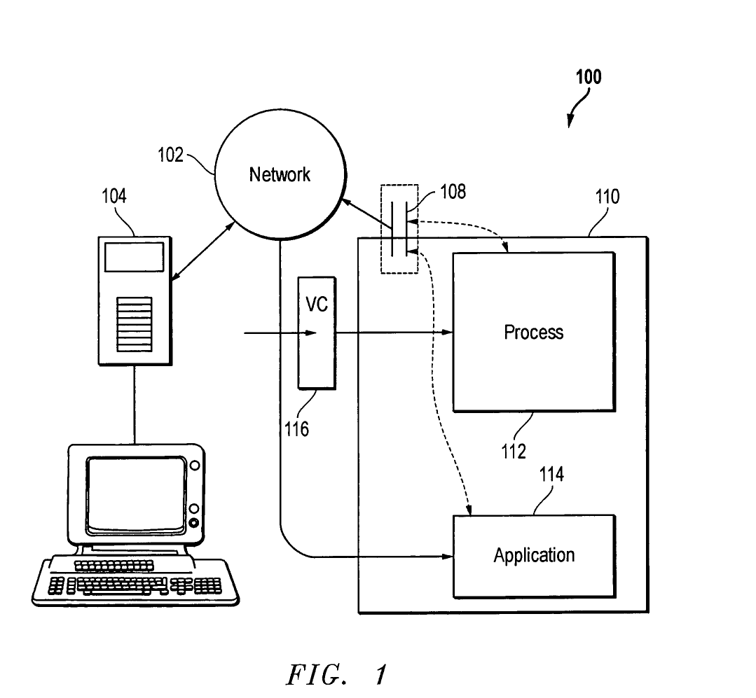

Referring to FIG. 2, a method 200 of operation of the virtual connector 116 includes a step of intercepting 202. In the intercepting step 202, data is extracted (i.e., selectively picked off) from a packetized signal passed over a communications channel, such as from the client computer 104 to the central computer 110 over the network 102 (shown in FIG. 1). The intercepting step 202 is fully functional with all types of the packetized signal, for example, the signal can include formatted (e.g., XML schema or web services enabled) or even semi-structured messages (e.g., self-describing type language; SOAP, HTTP or others).

In a step of mapping 204, the intercepted data that is extracted in the step 202 is mapped to a table or database. In the mapping step 204, the data is identified with a unique ID and is logically stored. In this manner, the extracted data is, organized for look-up and use in manipulation and other operations.

A step of semantic processing 206 thereafter follows the mapping 204. In the processing step 206, the data is manipulated. A wide variety of manipulation is possible. In certain applications, for example, the extracted data is semantically and structurally formatted for delivery to and use by the process 112 of the central computer 110 (of FIG. 1). Additionally or alternatively, the processing step 206 can include logic or flags for particular circumstances. Moreover, the step 206 can itself serve certain processing or other functions and operations, as desired for the particular implementation of the virtual connector 116. In any event, the virtual connector 116 can serve the function of making the data available to and useable by the process 112 or other desired software or hardware operations. Although the previous description particularly identifies the process 112 as an operational element that uses the extracted data once manipulated to useable form, the process 112 should be understood as including any and all possible applications and functions, including, without limitation, multiples and pluralities of those, desired for the particular application and data of interest.

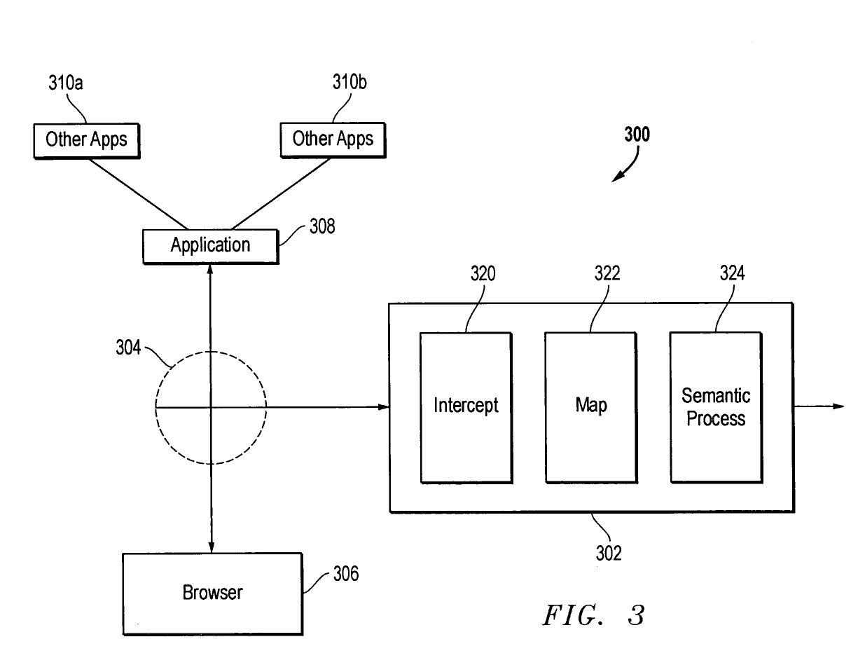

Referring to FIG. 3, an intelligence system 300 includes a virtual connector 302 of the type previously described. For purposes of illustration and example, the virtual connector 302 is illustrated as though employed in a typical user-interactive on-line transaction, such as over the Internet. In the example, a network 304, such as the Internet, communicatively connects a user's browser 306 (such as is operable on a client computer 110 shown in FIG. 1), to an application 308 (such as is operable on a central computer 112 shown in FIG. 1). As is typical, the application 308 can connect to other applications 310a,b, or otherwise.

The application 308 operates as an on-line interactive process, for example, a loan application operation. In operation of the application 308, the application 308 communicates information over the network 304 to the browser 306. The browser 306 displays the information to a user at the location of the browser 306. The user is required to interact at the browser 306, based on the information display, by providing input to forms displayed or otherwise. The interactivity of the user at the browser 306 includes communications of packetized signals from the browser 306 over the network 304 to the application 308. The communications of packetized signals can include data indicative of input by the user at the browser 306 to forms displayed at the browser 306. For example, the user can type-in customer identity information at the browser 306 and then cause the information to be communicated as packetized signals over the network 304 to the application 308, such as in the user making an on-line request for information, application for loan, or other interactivity.

The communicated packetized signals from the browser 306 over the network 304 are not directed wholly to the virtual connector 302; instead, the virtual connector 302 intercepts and extracts particular information of the packetized signals. In effect, the virtual connector 302 merely “sniffs” the signals and, via desired filters of the virtual connector 302, discerns information from the signals. Desired, information of the signals is then intercepted and extracted by the virtual connector 302. For these purposes, the virtual connector 302 includes an interceptor 320. The interceptor 320 captures the message off the dispatch from the browser 306 on the network 304. The interceptor 320 includes desired filters, for example, filters or patterns for SOAP, HTTP data, or other types/formatting/sequencing of data. In this manner, the interceptor 320 distinguishes particular types of information of the data, but the interceptor 320 does not necessarily determine the particular data itself. In fact, characteristics that are indicative of particular types are generally employed as the filtering criteria by the interceptor 320. When the interceptor 320 determines presence in the signals of desired information by virtue of data types and other patterns, the interceptor 320 extracts the particular data corresponding to the identified types or patterns.

A mapper 322 of the virtual connector 302 handles the extracted data to map the data with an appropriate identifier. The mapper 322 maps the data according to a semantic type or other distinction of each particular type of extracted data. In effect, the mapper 322 is an organizer and storage for the data, for example, similar to a look-up table or database arrangement. Each extraction is uniquely identified and mapped. As will be later described more fully, the mapper 322, together with other features of the virtual connector 302, permits real-time training for continually improving desired data extraction and handling, in addition to the runtime interception, and extraction of signals.

The mapped data of the mapper 322 is used by a semantic processor 324 of the virtual connector 302. The semantic processor 324 manipulates the mapped extracted data. The manipulations that are possible via the semantic processor 324 are virtually unlimited, and will generally be dictated by the application and requirements. Certain manipulations include, however, formatting and conversion of the data for use by other applications and processes (not shown), selective routing of the data or particular portions of the data, flagging of circumstances of the data for immediacy or other functions, and others. In an example implementation in an on-line transaction process, such as a loan application, the semantic processor 324 can perform such actions as further selecting data (e.g., HTTP data), preparing and formatting data (e.g., as required by interfaces of other applications, such as marketing, quality of service, or fraud functions), distilling the data (e.g., ascertaining certain conditions or input of the user), and any of a wide variety of other operations and uses of the data or portions of the data.

Proxy System:

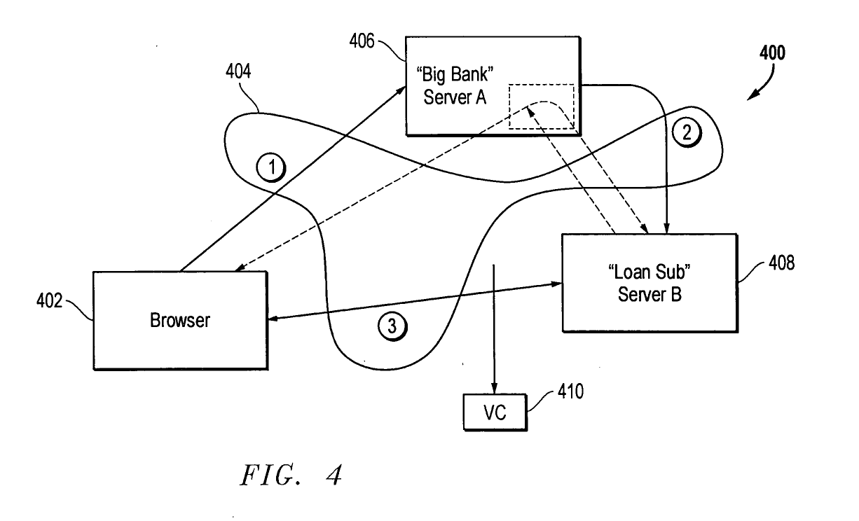

Referring to FIG. 4, a proxy system 400 for providing user link intelligence includes a user's browser 402 communicatively connected to a network 404. In the proxy system 400, the user's browser 402 is operable on a user computer and the network 404 is the Internet. Also communicatively connected to the network 404 are numerous server computers 406, 408, and other devices. The user's browser 402 communicates with the server computer 406 using conventional TCP/IP protocols. The communications include various HTML web pages and the like. In these communications, the user views the HTML pages, and other content served to the browser 402 over the network 404 from the server computers 406, 408.

The respective server computers 406, 408 are also communicatively connected over the network 404 (e.g., the Internet) or otherwise. The communicative connection of the server computer 406 with the server computer 408 permits linking. In the linking, the browser 402 displays a “link” on an HTML page served by the server computer 406. When the user of the browser 402 clicks on the “link”, signals are directed to the server computer 408, such as from the server computer 406, directing the server computer 408 to next serve to the browser 402 an HTML page or other content from the server computer 408.

In certain conventional arrangements of networked server and client computers, the communications between the server computer 406- and the browser 402, on the one hand, and the server computer 408 and the browser 402, on the other hand, occur between the respective sets. In other words, the server computer 406 and the browser 402 are either communicating or the server computer 408 and the browser 402 are communicating, where neither server computer 406 or 408 necessarily can detect communications by or with the other. In other conventional arrangements where the server computer 406 maintains detections of the communications with the server computer 408, the communications to and from the browser 402 with the server computer 408 must necessarily pass through the server computer 406. In this circumstance, the server computer 406 serves as a proxy for the communications between the browser 402 and the server computer 408. These proxy communications are illustrated for example in FIG. 4 as the phantom lines.

Still referring to FIG. 4, the proxy system 400, however, includes a virtual connector 410 as has been described. The virtual connector 410 can, for example, be included with or operable as part of or in cooperation with the server computer 406. The virtual connector 410 in the proxy system 400, in such instance, serves to provide the detections concerning the communications between the browser 402 and the server computer 408. Those communications need not pass through the server computer 406. Rather, the virtual connector 410 intercepts, maps, and manipulates data of the information of the packetized signals passing over the net-work 404 between the browser 402 and the server computer 408. Although the virtual connector 410 need not be maintained by the operator of the server computer 406, as the virtual connector 410 could be employed for any reason therefore, the operator of the server computer 406 could maintain the virtual connector 410 in order to discern and obtain the types of information that could otherwise only be available through the conventional proxy arrangement—i.e., in which the communications all pass through the server computer 406 as shown in the phantom lines illustrating the conventional arrangement.

In operation, the browser 402 communicates (shown as arrow “1”) over the network 404 with the server computer 406. When the browser 402 signals (shown as arrow “2”) to link to the server computer 408, the server computer 406 directs the server computer 408 to communicate (shown as arrow “3”) over the network 404 with the browser 410. The communications between the browser 402 and the server computer 408 thereafter need not pass through the server computer 408, and can occur naturally as routed by the network 404. The virtual connector 410 intercepts and extracts from the packetized signals communicated between the browser 402 and the server-computer 408.

There are numerous possibilities for implementation and use of the virtual connector 410 in such proxy system 400. The operator of the virtual connector 410, such as the source of the server computer 406, can glean information from the communications between the server computer 408 and the browser 402. This information can be important or desirable, such as to better service the user of the browser 402, to ascertain additional services suitable for that user, and to generally accomplish all of the various tasks and functions possible by use of the virtual connector 410 in any scenario.

HTML Content Extraction:

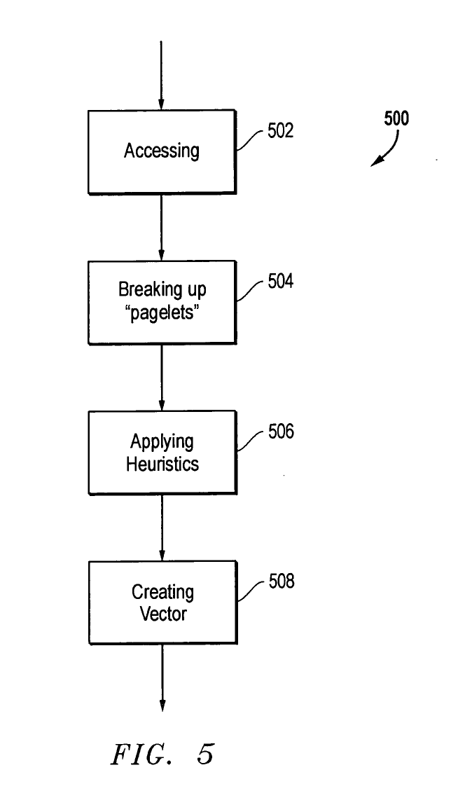

Referring to FIG. 5, a method 500 extracts HTML content from packetized signals. The method 500 is useable, for example, in the user-activity intelligence systems and processes previously described. For instance, the virtual connector which has been described can implement the method 500 in order to extract desired HTML content from packetized signals comprising multiple types of data, information, and content. Although the method 500 and HTML content extraction is described here with certain references to the previous discussion herein, the method 500 and its principles and implementations are not and should not be construed as limited to any particular embodiments or features of the prior discussion. Rather, the method 500 is effective in any circumstance, implementation or environment, as follows.

In the method 500, a step of accessing 502 obtains HTML data. Notwithstanding any specifically described embodiments of the accessing step 502 herein, the step 502 can include any or all means of accessing data, including HTML data. For example, the HTML or other data can be accessed programatically, (e.g., via a database, software application, or other data source) or bus, intercept (e.g., via network connectors, communications links, or other transit media). The accessing step 502 is, for example, performed in accordance with the foregoing described user intelligence system and method. Alternatively, the HTML data is obtained in any other typical manner, such as by downloading a website, provided from a distinct source, “sniffed”, or otherwise obtained. As is typical, the HTML data includes various types of information and content, including text, images, banners, links, and other typical web page and HTML data contents. The accessing step 502 is performable in real-time, on the fly, as data is communicated by download or otherwise, or is performable via batch or catalog processing.

A step of breaking up 504 the HTML content follows the step of accessing 502. In the breaking up step 504, the HTML data is broken into separate components, referred to herein as “pagelets”. The pagelets are each separate and distinct content subsets extracted from the HTML data. The distinct pagelets are determined and individually identified for separate componentization by analysis of syntactic or semantic (e.g., word sequence, location on page or file, particular language in multilingual content, or otherwise) flags in the HTML content. Either or both syntactic and semantic parsing of the pagelets is possible, as desired. As an example, an HTML web page containing elements of a jpeg image, a gif banner, and a text could be broken into individual pagelets according to these different elements—such as three pagelets, one comprising the jpeg image data, another comprising the gif banner data, and the other comprising the text data, as well as associated formatting information or other surrounding HTML that adds any visual or semantic: value to the content in question.

In a step 506, a series of heuristics is applied to each pagelet's contents. The application of heuristics in the step, 506 is dictated by the application and approach. The particular number and type of the heuristics is dependent upon the desired operations and results. Particularly, the ordering of the heuristics, so applied, the number and type of the heuristics, and the arrangement and groupings of the heuristics can all have implications to the results from the heuristics and the method 500. Further, the heuristics and their application can be logically applied or sequenced. Generally, important aspects of the pagelets for applying heuristics in the step 506 will include syntax, structure and combinations of the HTML data of the pagelets. The step 506 applies heuristics to these (and possibly other, depending on the application) aspects of the pagelets.

From the results in the step 506 of applying heuristics, a vector is created in a step 508. The vector is a listing of the heuristic values determined for a distinct pagelet, from the step 506. Those heuristic values are listed as a scalar (e.g., “x_y_z_”). This vector from the step 508 can be considered as a “fingerprint” of the pagelet, that is, a uniquely identified set of heuristic information about the pagelet syntax, structure and combinations of features. The vectors created in the step 508 are useable for comparison and logical operations. The vectors are so useable for determinations and processing in order to analyze and assess HTML content. Regarding the user-activity intelligence systems and methods which have been described, for example, real-time HTML content communications can be analyzed via creation of the vectors and the method 500. The vectors from intercepted and extracted communicated information, by means of comparison and evaluation of the vectors, reveals aspects of the communicated information in real-time without undue interference and intrusion in the communications.

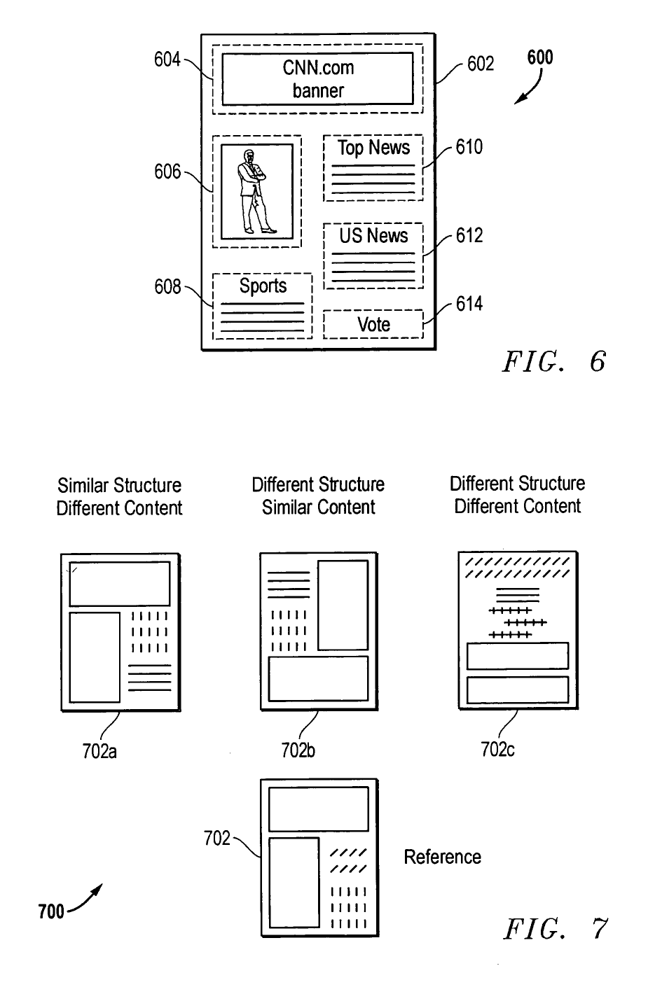

Referring to FIG. 6, an exemplary HTML web page display 600 includes various types and structures of data and content. The HTML web page data 602 comprises, as is typical, various syntax and structure. Syntactic flags (not shown in detail) of the HTML syntax corresponding to the HTML web page data 602, and forming the HTML web page display 600, permit the page data 602 to be separated or broken up into distinct pagelets—i.e., subsets of the entire page data 602. The distinct pagelets in the example of FIG. 6 are indicated by the phantom boxes numbered 604, 606, 608, 610, 612, and 614. The pagelet 604 is a banner heading. The pagelet 606 is an image. The pagelet 608 is a “SPORTS” text section. The pagelet 610 is a “TOP NEWS” text section. The pagelet 612 is a “US NEWS” text section. The pagelet 614 is an interactive form “VOTE” block. Although the pagelets indicated in FIG. 6 correspond roughly to disparate syntactical and structural components/elements of the page data 602. The particular pagelets of HTML data in any instance, however, can vary based on the particular application and desired results therefrom. Thus, pagelet construction and determination can vary according to preference, configuration and programming. In any event, the pagelets are each individually handled by applying heuristics and vector creation corresponding thereto, as in the method 500 of FIG. 5.

Referring to FIG. 7, exemplary alternative web pages 700 are shown as reference HTML page 702 and HTML pages 702a, 702b, and 702c. The web pages 700 illustrate the variation that can be possible among the reference page 702 and three similar pages 702a, 702b, 702c. The respective pages 702a, 702b, 702c are each similar, however, they differ in structure and/or content. Particularly, page 702a illustrates an HTML data page of similar structure, but different content, from the reference page 702. The page 702b illustrates an HTML data page of different structure, but similar content, from the reference page 702. The page 702c illustrates and HTML data page of both different structure and different content from the reference page 702. In the method 500 of FIG. 5, each of these pages 702, 702a, 702b, 702c is accessed, is broken into pagelets, heuristics are applied, and vectors are created. The vectors are then compared, logically, using fuzzy matching techniques, subject to probabilistic analysis or otherwise, to ascertain aspects of the syntax and structure of the respective pages 702, 702a, 702b, 702c. In this manner, intelligence is gleaned regarding the information, content and other data aspects of each of the pages 702, 702a, 702b, 702c.

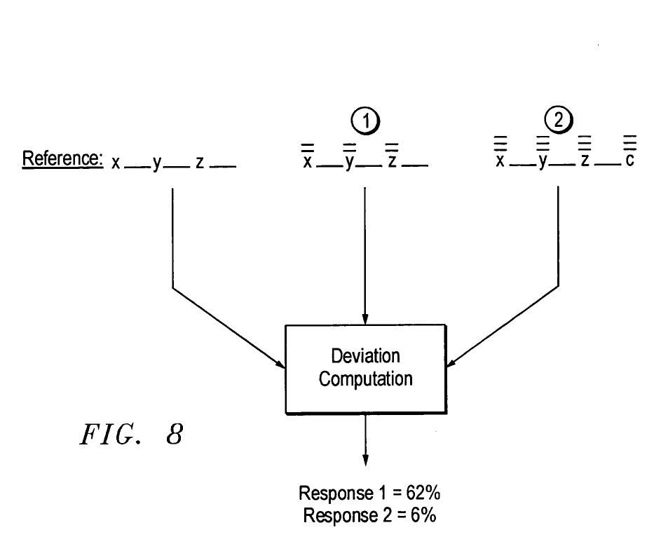

Referring to FIG. 8, a comparator 800 of vectors is illustrated. For purposes of example, assume that the following heuristic values are obtained via the method 500 of FIG. 5 with respective reference HTML data page and two separate instances of varied content HTML data pages.

Values from

| Heuristics | Characteristic/Measure |
|---|---|
| x | Ratio of image to non-image content |
| y | Ratio of numeric to non-numeric content |
| z | Formatting complexity measure |
| c | Other characteristic |

For the respective HTML data pages, each of these values from heuristics is obtained corresponding to the respective pagelets from each separate HTML data page (or other HTML data unit, as the case may be). The reference HTML pagelets yield scalar values that when transformed into a vector result in: x_y_z. Pagelets of one of the varied HTML data pages yield scalar values that when transformed are the vector: x′_y′_z′_. Pagelets of the other of the varied HTML data pages yield scalar values that when transformed are the vector: x″_y″_z″_.

In the comparator 802, a deviation comparison is made between each of the vectors x′_y′_z′_ and x″_y″_z″_, and the reference vector x_y_z_. The comparator 802 yields a measure of the deviation comparison performed thereby. For example, if the HTML data page of the vector x′_y′_z′_ is relatively dis-similar in the measured heuristics values to the reference vector, then the measure of deviation may yield a higher value, e.g., a 62% value—this being indicative of relative dis-similarity of the reference and other HTML data pages. On the other hand, for example, if the HTML data page of the vector x″_y″_z″_ is relatively similar in the measured heuristics values to the reference vector, e.g., such that the respective reference and other page are structurally and syntactically similar in most respects, then the measure of deviation may yield a lower value, e.g., a 6% value. This lower measure of deviation suggesting that there are significant similarities in the reference and this other HTML page data. Via such methods and comparison, intelligence is gleaned of respective HTML data.

Although not shown or described in detail here, the method 500 of FIG. 5 and the entire HTML content extraction and analysis here illustrated are applicable to any and all HTML data, not merely web pages. For example, HTML records can be similarly extracted, such as, for example, multiple records obtained from search engines or the like. In any instance of the application of the HTML content extraction and analysis, similar fuzzy matching and deviation comparison, via pagelet construction and vector creation, are employed for gaining intelligence of the respective HTML data.

### EXAMPLE

An example of the foregoing user-activity intelligence systems and methods, employed together with the foregoing HTML content extraction and analysis, is now discussed. The example is employable in multitudes of situations for business activity monitoring and otherwise. In application in the example, communicated messages are accessed for intelligence determinations. The communicated messages can be on-line business transaction processes, internal communications, inter-applications communications, data generated internal to any particular application or applications, or any of a wide variety of other sources of data. In the example, the particular messages are accessed and the operations occur in real-time. Results of and from the operations are widely variable, according to desired usages and intentions, including the subsequent uses and operations with the results.

The example system is referred to as the Visibility Management Platform (VMP). The VMP focuses on enabling and providing enterprise-wide visibility (i.e., intelligence) into discrete business functions as and when they occur in real-time. The VMP is an application-level process manager. As such, the VMP provides visibility into a business activity as it is occurring, for example, particularly into user-activity in a Internet web-based online business transaction process or the like. In effect, the applications managed by the VMP are capable of tracking, in real-time, the progress of individual users as they perform activities and transactions using web-based business applications.

In operation, the VMP extracts real-time data about business activities being performed via applications, and applies analytical and correlation capabilities to the information of the data. The VMP, in this manner, makes the real-time data derived thereby meaningful information, which meaningful information can then be used or viewed for a wide variety of purposes. The VMP provides these capabilities by limiting the amounts of information to what is important, from the multitudes of data in any business transaction scenario.

VMP System General Functionalities:

The VMP obtains and manages the application level visibility (i.e., the real-time knowledge gleaned from the application), independently of the actual applications, such as, for example, online business transactions and the like. This approach provides several key capabilities, including the following:
1. Tracking user-level activities without modifying existing application code.
2. Dynamically defining alerts and the corresponding filters and thresholds without modifying existing application code.
3. Integrating existing applications with various business process management systems (e.g., personalization fraud detection, marketing and other ancillary applications) without substantial intrusiveness to the existing applications and communications.
4. Tracking and logging to enable analytics and insight to drive ancillary and integrated decision making processes.
5. Logically connecting and integrating independent existing applications, including to provide visibility into operations across the enterprise or at least into multiple applications, transactions, processes or activities.
   Data Collection

A key aspect of the VMP is capability to “monitor” data-streams that contain information relevant to business activities being performed. Based on such monitoring, extensions of the VMP concepts, via ancillary applications and processes and otherwise, provide many possibilities for overall business monitoring, analysis and decision-making. This monitoring via the VMP includes the following:
1. Separating protocol-specific functionality from generic functionality applicable to information from every data source.
2. Supporting means to incrementally incorporate protocol-specific functionality for additional protocols
3. Providing mechanisms to “map” protocol specific functionality into common, generic functionality.

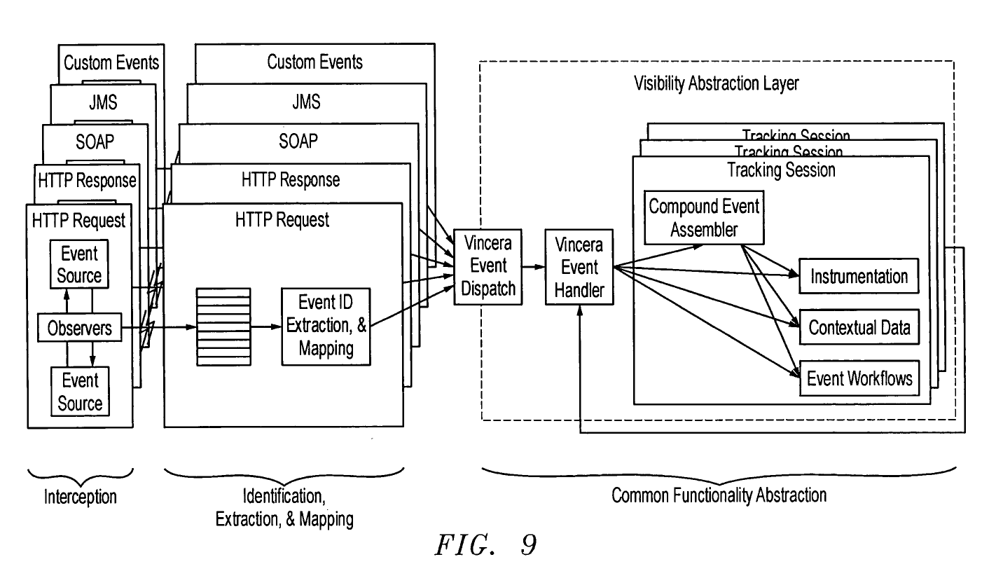

Referring to FIG. 9, the VMP, generally, comprises three distinct, logical layers. The layers include the following components:
Interception Layer: A series of protocol-specific modules designed to observe and intercept raw messages, in their native format, from within a message data-stream. The interception layer does not affect functionality in existing applications that utilize the message stream being observed.
Identification, Extraction, and Mapping Layer: A series of protocol-specific modules contextually identifies each relevant message obtained from the Interception Layer, extracts desired data from the message, and maps the data into functionality in a Common Functionality Abstraction Layer.
Common Functionality Abstraction Layer (also referred to herein as “Visibility Abstraction Layer” or “VAL”): The Common Functionality Abstraction Layer operates on the intercepted information to make the information available for desired uses, and includes such operations as workflows, data manipulations, event generation, redirection and numerous other possible functions. For example, the Common Functionality Abstraction Layer makes the information available—in appropriate form, format and otherwise—for use in various Business Value Modules, as hereafter described.
   Business Functionality

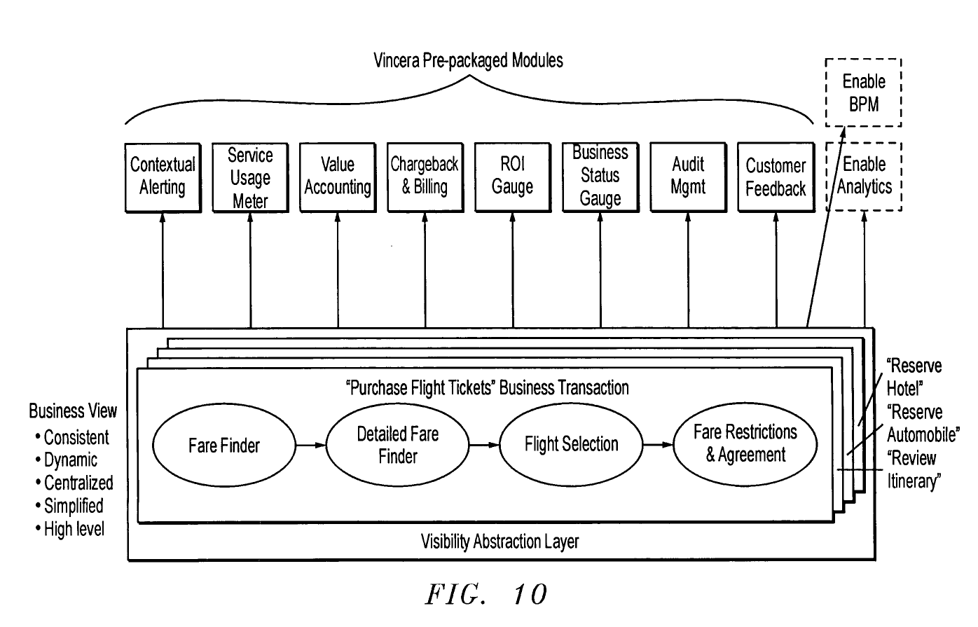

Referring to FIG. 10, he VMP provides the data collected (i.e., the intelligence) in forms and formats suitable for various business functions and operations. These business functions are broadly referred to herein as the Business Value Models of the VMP. In effect, the Business Value Models are any applications or processes that use the intelligence provided by the VMP from data collection. The Business Value Models are, for example, software applications that perform statistical functions on the data, that perform further manipulations of the data, or that direct or flag information for critical or other purposes, including the following examples:
Contextual Alerting Module
   Target notification to interested individuals
   Triage event notification by filtering events through rule-based data-values processing
   Support tracking of event notifications for trending and analysis
Event Correlation Engine
   Map the data and events being monitored into patterns, which can be used to identify higher level business situations
   Support associating high-level events with data regarding historical business response patterns
   Use patterns to “fingerprint” individual users and interaction scenarios to help profile and classify them (Example: Is this screen-flow pattern characteristic of a user who is a potential buyer, or just a browser?)
Service Usage Meter Module
   Represents business activities as software services
   Tracks which services are used, when, and for how long
   Associates each use of a service with an account or customer
   Tracks whether each use of the services was “successful” or not based on classification outcome defined in Visibility Abstraction Layer
Value Accounting Module
   Associates a dollar value with each use of a service
   Supports different pricing models by customers, accounts, or other characteristics
   Supports tiered pricing models based on customer status
   Supports volume discounts based on usage
   Generates periodical itemized reports by service or by customer to show total value
   Maintains cumulative statistics on service usage and associated value
Chargeback & Billing Module
   Generates invoices based on information generated by Value Accounting Module
   Can be integrated with third party billing services
ROI Gauge
   Generates real-time statistics based on information collected from Value Accounting Module to evaluate total Return on Investment (ROI) for each service
   Supports grouping services together to evaluate collective ROI
   Can be configured with information about total investment for each service.
   Uses this information in ROI calculations
Business Status Gauge
   Accumulates the results of each service based on classification tags for the service (as configured in the Visibility Abstraction Layer)
   Supports the presentation of information in a web-based “executive dashboard”
   Supports dynamic selection of which information is presented
   Supports grouping of services and aggregation of information from service groups
Audit Management Module
   Detailed log that is generated that represents all of the interactions between the user and the system for each business activity that is performed
   Graphical user interface that lets business users access audit trails over the web
   Drill-down capabilities to select individual sessions by customer, account, group, and others
Customer Feedback Module
   Supports the ability to associate customer surveys with any page in an existing application
   Will record customer feedback for the session or for each page and will save the feedback off with the audit trail
      Of course, numerous other and widely varied Business Value Models, together with widely varying functionalities and uses, are possible and all are included for purposes of the VMP and operations.
      Data Management

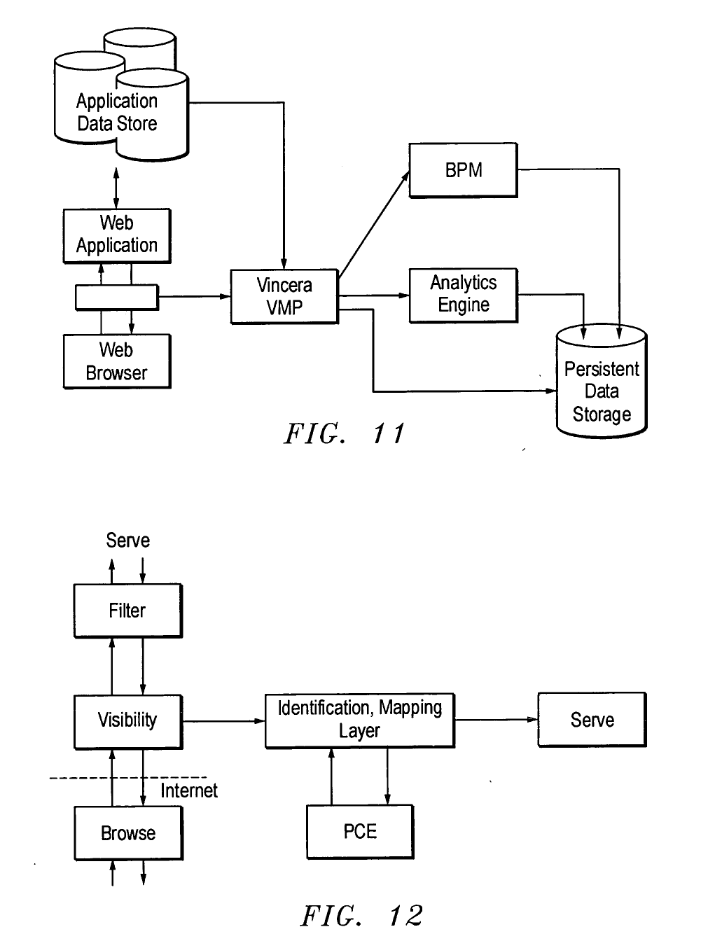

Referring to FIG. 11, the VMP also manages the data that is so collected, manipulated, and analyzed. Particularly, the VMP data management functions provide the following capabilities, among others:
Ability to work with all data (in the form of variables) coming through visibility (i.e., intelligently monitored or ascertained) events
Makes data available for use in the Visibility Abstraction Layer in a structured, uniform fashion. Examples include:
   instrumentation
   extensibility algorithms (rules, queries, user defined services)
Makes the results of extensibility algorithms available for use in other ancillary or non-VMP respects
Supports data management model that is usable and maintainable
Distinguishes between reliable data (data local to an event) and unreliable data (data that depends on certain non-mandatory activities having occurred prior to whatever function or element needs the data)
Supports dynamic data (e.g., dynamic number of line items on an order)
   VMP System Components:

At the highest level, the VMP comprises two main subsystems—(A) the runtime VMP Server system and (B) the Configuration Workbench.

VMP Server

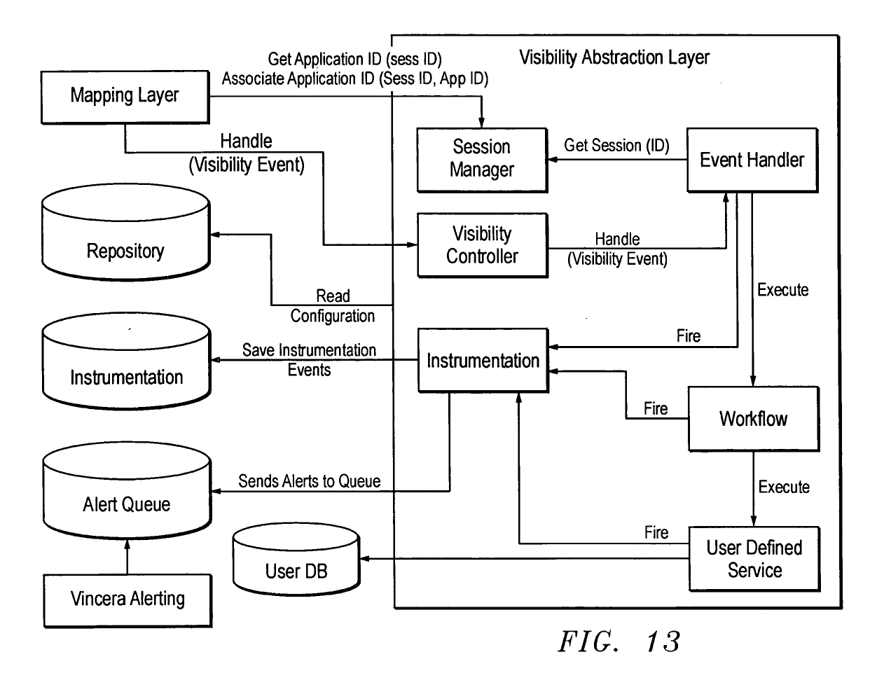

Referring to FIG. 12, the VMP Server provides runtime functionality to track data communications (“Business Activities”) as they are being performed within existing applications. The VMP Server operates based on configuration settings as defined in a meta-data model by a VMP Configuration Workbench (later described).

The VMP Server is driven by metadata stored in a repository by the workbench. The metadata is organized by model, and then by application. The model exists so that UDS, Queries, and Constraints can be reused within this scope, and run off the same (model) data. The application being then intelligently analyzed, in each event, is, for example, a pre-existing web application that the running of the VMP is based on. This allows the mapping layer to run largely off one application, thus allowing for efficient request and response matching. The application scoping is also relevant to configuration of session data, as the session in the existing web app corresponds to one application.

The VMP Server comprises three functional layers:

VMP Layer 1: Message Interception:

The message interception layer captures messages between systems and makes them available for processing by visibility (i.e., knowledge) services in the VMP. For the HTTP Request/HTTP Response components of the interception layer, the VMP uses filters on an HTTP server to capture the message stream. The interception layer filters operate between the browser and the production server in communications, and they intercept the request and response messages in native formats. Once intercepted, the filters pass the messages to the Identification, Extraction, and Mapping layer for conversion into a format that can be processed by the VMP Visibility Abstraction layer. Intercepted messages of differing protocols (or even differing implementations of the same protocol) can require different physical implementations of the interception layer components.

VMP Layer 2: Identification, Extraction, and Mapping:

The identification, extraction, and mapping layer takes the native HTTP Request and HTTP Response messages and converts them into a generic format that can be used by the Visibility Abstraction layer (VAL). This conversion occurs by steps of identification of the message (i.e., a Visibility Event) relative to its representation (e.g., importance or desirable indicators) in the relevant visibility model then being employed, extraction of the requested data from the native message format, and mapping of the data into appropriate Visibility Event Handlers that are understood by the VAL, as more fully hereafter described.

Each type of protocol for the VMP operations must be distinctively and uniquely identified, extracted, and mapped to obtain the desired results from the VMP operations. The VMP, therefore, includes sets of VMP Layer 2 components unique and specific to individual ones of the wide variety of possible HTTP Requests, HTTP Response, JMS messages, SOAP messages, and other data and protocols. For HTTP Requests and HTTP Responses, for example, a separate implementation of a Java version of Layer 2 components, as well as a C/C++ version (for support of interception via ISAPI and Apache filters), can be employed.

VMP Layer 3: Visibility Abstraction:

The visibility abstraction layer (VAL) is logically and physically distinct from the other two layers (i.e., the Interception and the Identification, Extraction and Mapping layers). The VAL, unlike the other two layers, is generic to all of the different kinds and types of native messages, and is not unique or specific in these respects as to protocol or types. The VAL accepts an invocation of a Visibility Event Handler, along with a generic “datagram” as input. The datagram includes an ID (i.e., unique identifier) of the appropriate Visibility Event Handler (identified in the mapping layer) to be invoked.

The VAL takes Visibility Events identified in the mapping layer, and invokes the appropriate Visibility Event Handler for each Visibility Event. The Visibility Event Handler performs actions based on the data in the datagram. The functionality of each Visibility Event Handler is configurable via the Workbench, and consists of Instrumentation, Workflows (sequences of Services, Conditionals, Queries and Instrumentation), and data manipulations specific to the Event Handler. Upon VMP Server initialization (i.e., via initialization of the Event Hanlder), various ones of the Visibility Event Handlers (with their associated Workflows and Instrumentation) are created and stored in memory from the configuration information in the database repository.

In certain arrangements, the VAL is included in the Mapping Layer components. If scalability is a requirement, then separate scalability requirements may apply to the several layers. The layers may, therefore, be separate components and implementations in such instance.

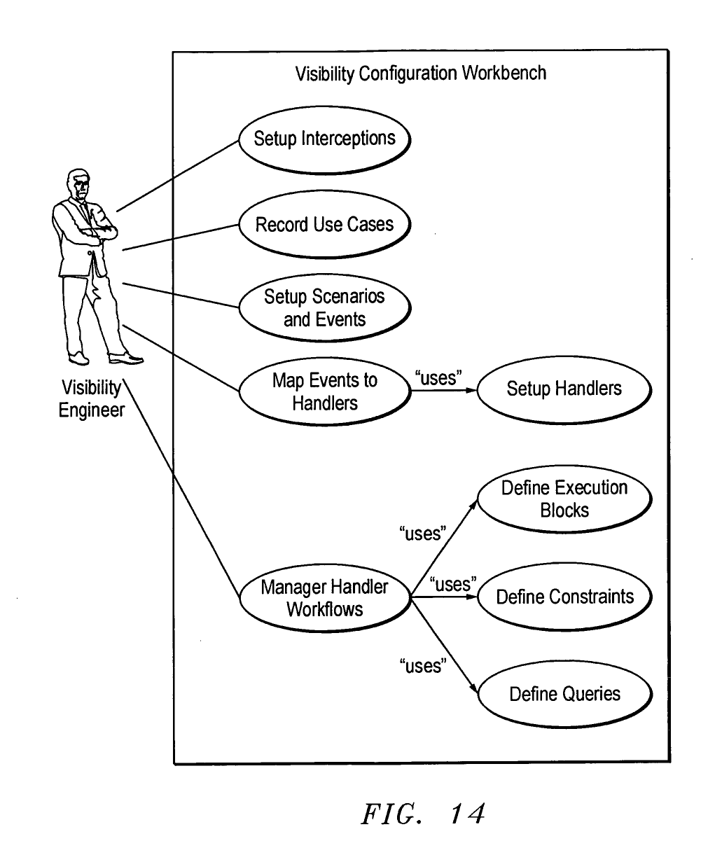

Referring to FIG. 13, the VMP Server and components are further described, as follows:
The Visibility Controller. The Visibility Events, and passes them to the correct Event Handler. The Visibility Controller keeps a map of the Event Handlers for this purpose. The Visibility Controller may be implemented as a stateless session bean, if the Session Manager is implemented as a network singleton.
Session Manager. The Session Manager returns unique sessionId's to the Mapping Layer. It also creates Session objects, that can be retrieved by the Event Handlers by sessionId.
Event Handler. Each instance of this class is configured by the workbench with associated Workflows (and Instrumentation), and data mappings to variables in Analytic Namespaces. Each, instance is created at server initialization, and a Visibility Event is passed to it when it is invoked. The Event Handler uses the sessionId to retrieve the relevant session from the Session Manager. It then constructs a Data Accessor for its scope, the Session scope, and the Global scope, and passes this to the workflow. In the Instrumentation, when there are multiple workflows associated with an Event Handler, the Event Handler will also have instrumentation associated directly with it. After the Workflows have returned, the Event Handler executes the update/delete actions for the Visibility Event data into session and global scope.
Workflow. Workflows are associated with each respective Event Handler, from configuration information in the repository. The Workflows are logically an extension of the Event Handler (as they take Visibility Event data and perform actions), but provide multiple sets of actions associated with an Event Handler. In certain arrangements, there is one Workflow per each Event Handler. The Workflows consist of Transitions, User Defined Services, Instruments. When a Workflow is executed, it takes the Data Accessor passed to it, and creates its own version, wrapping the passed-in Data Accessor. In this way, the Workflow scope data is dereferenced and subject to disposal when a workflow.execute method returns.
User Defined Services. User Defined Services (UDS) are a principal means through which visibility (i.e., data intelligence) can be extended to perform custom functions. UDSs can be Java classes that implement the IService interface, JavaScript methods, SQL, and stored procedures specifically written for desired function. UDSs are invoked using parameters. The parameters can be mapped to variables from various scopes in Analytic Namespaces (see Data Management). UDSs have return values (“output parameters”) that can also be mapped to variables from various scopes in Analytic Namespaces. UDSs can also perform arbitrary actions when they execute
Instrumentation. Instrumentation takes input parameters and sends resultant data to special instrumentation “Event Handlers”. There are two types of instrumentation events. Alert events are processed by the Alert Handler, that invokes an Alerting application for real time alerts. The other instrumentation analytics events are processed by a DBEvent Handler, which stores them in the Instrumentation database. Instrumentation is part of the extensibility model, since it is possible for a customer to implement their own instrumentation Event Handler to interface alerts or analytics to different processing.
   Configuration Workbench

Referring to FIG. 14, the Configuration Workbench can serve as a. Visibility Event workflow management tool or other functions in the particular application environment. The Configuration Workbench, generally, models how messages in the application data streams are to be monitored. The VMP applies a process called “Contextualization” to map or pattern individual messages (i.e., corresponding to desired Visibility Events) into an abstract representation of Business Activities.

Setup & Recording

Contextualization is performed by “recording” Use Cases consisting of Business Activities being performed by the execution layer of the application. The message stream involved in the application is captured for each Use Case and made available to the Configuration Workbench for modeling. The captured messages from one or more Use Cases are combined into logical “superset” representations, and modeled as Visibility Events.

A Visibility Designer records the Use Case sessions. Recording involves configuration of a proxy server. The Use Case Recorder includes a web browser component configured to communicate with an HTTP server through the VMP proxy server. The user specifies the starting. URL for the web application and when to start or stop recording. The system then captures the message stream representing the user's activities during that web application session by intercepting the messages via the VMP proxy server. The system also provides some information in order to refer to the session at a later point.

As each message is captured and recorded, the system permits specification of a logical name representing the message. This is supported for both HTTP Request messages and HTTP Response messages.

Modeling

A scenario modeling wizard steps through a process of selecting HTTP Request and HTTP Response messages (in their native formats) from the recorded Use Case sessions, specifying Visibility Events to be created from the native messages, and specifying properties of the native messages to be used in identifying and extracting data from these events.

Event Handler Editing

Event Handlers can be created for an associated Visibility Event or created independently. There are three basic components comprising each Event Handler:
General Event Handler properties: Name, ID, Parameters
Session manipulation: Event Handler variable to Analytic Namespace variable mapping
Workflows
   Upon successful creation, Event Handlers are displayed in the Event Handler repository.
   Workflow Setup

Each Event Handler has properties and optional workflows associated with it. For a given Event Handler, a list of workflows is displayed. Each workflow is sequenced. Upon workflow selection, a workflow layout is displayed in a workflow canvas. There are two kinds of nodes—service nodes and composite nodes—available in the canvas. Each workflow has a top-level canvas. The top-level canvas has a start node for each workflow. Workflow management is performed from a panel within the Event Handler Editor.

Event Handler Mapping

Mapping of parameters from a Visibility Event to parameters of an Event Handler is performed in order for the Mapping layer to invoke Event Handlers in the VAL. Invoked Event Handlers cause invocation of the corresponding workflows in respect of the particular Event Handlers. Mapping between Visibility Event parameters and Event Handler parameters is made via a parameter mapping editor. An unmapped event is ignored by the VAL.

Execution Block

The services workflow nodes on the workflow canvas represent a list of execution blocks. Each execution block is a reusable service instance that has been configured based on a previously defined service template. A service is an abstract function that can be invoked from within the VMP. Data can be exchanged between these instances.

Constraint

Constraints are a Boolean evaluation that determines whether or not an operation can be performed. Multiple constraints (a “constraint chain”) can be assigned to a function in the VMP, such as the traversal of a transition or the invocation of a service. The constraints are evaluated in sequence until either all of the constraints have passed (i.e., all return “true”) or a constraint fails. As soon as a constraint on a VMP function fails, the function fails to execute. Once a constraint in a constraint chain fails, no other constraints in the chain are evaluated.

Query

Queries are reusable query templates that can be used to pass data to constraints and services. A query editor creates the queries. When a constraint or a service instance is applied, the parameters to the queries must be filled.

Repository Management

Repositories provide a mechanism to view and edit all the entries and data in the system. There are three distinct repositories in the system:
Event Handler Repository: groups Visibility Event Handlers by category. The Event Handler Repository is of prime importance in the Configuration Workbench. The VAL kicks off workflows based on these Event Handlers
Business Constructs Repository: manages execution blocks, constraints, and queries
Namespace Repository: displays the association of scoped variables with a user-defined namespace; this gives an additional flexibility in grouping variables. There are be two views associated with this repository—Namespace Scope view and a Scope Namespace view. This approach of multiple views for a given repository will be similar to our existing approach applied to business constructs repository
   Maintenance

The Workbench can have deletion functionality for all objects created in the Workbench, including such items as recorded Use Cases, Visibility Events, and Event Handlers. Use Case deletion can be a feature of the Use Case Recorder or Scenario Modeling. Visibility Events and Event Handlers can be managed for deletion through a View Repository, similar to other objects. Deletion of a Visibility Event can automatically remove any associations referencing the Visibility Event (i.e., such as the respective Event Handler and Request-to-Response). Similarly, deletion of an Error Handler can remove its respective associations. A confirmation message can warn of any existing references/associations to be deleted thereby, before final deletion.

Additional maintenance features can include matters such as the following:
Change reconciliation between the Visibility Models and application functionality at the execution layer. When the nature of actual. Visibility Events change, for example, due to modification of the modeled web application, available tools reconcile these changes with created Visibility Events. Changes such as additional or missing parameter data is detected and displayed.
Object & Analytic Namespace management functionality. Namespace management provides a Namespace-level view of application variables.

Within the view, changes can be made to items such as renaming, adding, and removing variables.
Object management enhancements include such tools as the ability to Cut, Copy, and Paste repository objects.
Expiration of Use Cases based on “valid dates”

### End of Example

The foregoing systems and methods have wide application in a variety of environments, including business applications, on-line processes, transactions, and other scenarios. In all such instances, real-time visibility and intelligence is provided into communications and other data streams in the application. Although certain applications are mentioned and referenced in the description and examples, the systems and methods are not limited to such applications. In fact, the systems and methods can be employed to provide insight and knowledge of any computing activity or communication involving packetized data. Added and extended capabilities for operations with the gained insight and knowledge of the computing activity or communication are virtually unlimited in possibility and potential. The various models described herein for using and operating with the relevant insight and knowledge gleaned by the systems and methods are merely examples, as any and all other models can be programmed and employed as desired for the sue and operations.

In the foregoing specification, the invention has been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention.

Benefits, other advantages, and solutions to problems have been described above with regard to specific embodiments. However, the benefits, advantages, solutions to problems and any element(s) that may cause any benefit, advantage, or solution to occur or become more pronounced are not to be construed as a critical, required, or essential feature or element of any or all the claims. As used herein, the terms “comprises, “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

1. An activity intelligence system, having a channel of a communication, comprises:
an interceptor for accessing data of the communication;
a mapper for indexing the data; and
a processor for performing an operation with the data.

2. A method of intelligent analysis of a data, comprising the steps of:
accessing the data;
mapping the data; and
processing the data.

3. A method of real-time data analysis, comprising the steps of:
accessing a data communication in real-time;
parsing the data communication in real-time;
storing a select data of the data communication in real-time; and
processing the select data.

4. A system for content extraction, comprising:
an interceptor for accessing a data of a communication;
a breaker for breaking-up the data of the communication into at least one subset;
an analyzer for applying heuristics to the at least one subset; and
a vectorizer for creating a scalar value of the at least one subset and transforming the scalar value into a vector.

5. A method of content extraction, comprising the steps of:
intercepting a data of a communication;
breaking-up the data of the communication into at least one subset;
applying heuristics to the at least one subset;
creating a scalar value corresponding to the at least one subset;
transforming the scalar value in a vector; and
computing a deviation of the vector compared to another vector.
